(19) United States
(12) Patent Application Publication
(10) Pub. No.: US 2015/0186809 A1
(43) Pub. Date: Jul. 2, 2015

(54) SYSTEM AND METHOD FOR TRACKING AMI ASSETS

(71) Applicant: Florida Power & Light Company, Juno Beach, FL (US)

(72) Inventors: Sunita Hawaldar, Miami, FL (US); Paul Ollukaren, Palm Beach Gardens, FL (US)

(73) Assignee: Florida Power & Light Company, Juno Beach, FL (US)

(21) Appl. No.: 14/584,377

(22) Filed: Dec. 29, 2014

Related U.S. Application Data
(60) Provisional application No. 61/921,851, filed on Dec. 30, 2013.

(51) Int. Cl. G06Q 10/06

(52) U.S. Cl. CPC G06Q 10/0631

(57) ABSTRACT

Disclosed is a system for tracking AMI assets. The system includes a product tracking database and a number of interfaces that provide access to the database. Different modules can communicate with the database, which include an administration module, a device management module, an UPR management module, a documents module, an assets module, an indicator group module, an inventory module, and a reports and dashboard module.

### FIELD OF THE INVENTION

The present disclosure relates to systems and methods for tracking assets or products in an advanced metering infrastructure (“AMI”) network.

### BACKGROUND

While implementation of the smart grid offers advantages to the utility industry, it also poses challenges. One such challenge is to manage AMI network assets (for example, smart grid devices, not limited to AMI meters) as these assets change and become reconfigured. Another challenge is to manage the inventory of secured devices.

These challenges stem from the needs to handle large quantities of information and to process the information in real-time. The smart devices need to be managed throughout their lifecycle for configuration changes, firmware updates, compatibility issues, etc.

Therefore, there is a need in the art to identify and address gaps in existing systems and business processes which may be resolved by a comprehensive Asset Management Solution (AMS) and related business process re-engineering.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate the scope of the system and method disclosed herein. Its sole purpose is to present some concepts of the disclosure in a simplified form as a prelude to the more detailed description that is presented later.

In one embodiment, the system of the present disclosure tracks an asset from the time the asset is received from the manufacturer or supplier, to the time the assets is retired or disposed of, and any activities in between. The system may handle end-to-end processing of asset inventory information and provide visibility into the life cycle of smart assets including meters and other network components.

An object of the present invention is to provide current, reliable and accurate AMI asset information throughout each asset's lifecycle, including but not limited to the business processes identified below:

1. Inventory Management—An object is to maintain accurate inventory of AMI assets down to the customer premise/field location/store/service center/truck/bin-level detail;

2. Procurement Management—An object is to optimize the procurement of AMI assets due to enhanced visibility of the current inventory;

3. Quality Acceptance (QA) and In-service Statistical Sampling Testing—An object is to track movement of meters as part of the QA and In-service statistical sampling testing performed by a Meter Technology Center (MTC);

4. Deployment—An object is to track AMI assets being deployed in service areas by contractor/utility crew;

5. Maintenance and Work Planning—An object is to provide inputs to support corrective and preventive maintenance of AMI assets through failure reporting and condition monitoring;

6. Revenue Protection Regulatory Evidence—An object is to track the AMI assets as part of the revenue protection regulatory evidence process; and

7. Asset Decommission—An object is to provide inputs to an asset decommission process and facilitate reuse of component parts of AMI assets.

Advantages of the present invention include:

1. Greater visibility of assets throughout the supply chain, inventory and operations;

2. Support of “just-in-time” inventory management: reducing the need for inventory storage and related carrying costs;

3. Single Source of Truth of asset information across all business units;

4. Access of asset information for support of engineering reliability analysis;

5. Improved Emergency Response Efficiency;

6. Standardization of AMI asset identification, information and processes along with scalability and flexibility to address future changes;

7. Improved Maintenance Tracking and Forecasting; and

8. Operational Efficiency Improvements for AMI Network Operations, ISC, Field Meter Shops, Distribution, Revenue Protection Regulatory Evidence personnel and Meter Technology Center resources.

The following description and the drawings set forth in detail certain illustrative aspects of the disclosure. These aspects are indicative, however, of but a few of the various ways in which the principles of the system and method disclosed herein may be employed and the system and method disclosed herein is intended to include all such aspects and their equivalents. Other advantages and novel features of the system and method disclosed herein will become apparent from the following detailed description of the system and method disclosed herein when considered in conjunction with the drawings.

### BRIEF DESCRIPTION OF THE DRAWINGS

FIG. 1 illustrates a mindmap of the AMI Product Tracking System (“AMI-PTS”) in accordance with one embodiment;

FIG. 2 illustrates a Context Diagram of the AMI-PTS system in accordance with one embodiment;

FIGS. 3A-C illustrate an exemplary architecture of the AMI-PTS system in accordance with one embodiment;

FIG. 4 illustrates an AMI-PTS interface diagram in accordance with one embodiment;

FIG. 5 illustrates an exemplary physical architecture of the AMI-PTS system in accordance with one embodiment;

FIG. 6 illustrates a Dashboard architecture for use with the AMI-PTS system in accordance with one embodiment; and

FIG. 7 illustrates an enterprise view of the life cycle of products in accordance with one embodiment.

### DESCRIPTION OF ILLUSTRATIVE EMBODIMENTS

The system and method disclosed herein will now be described more fully hereinafter with reference to the accompanying drawings, in which preferred embodiments of the system and method disclosed herein are shown. The system and method disclosed herein may, however, be embodied in many different forms and should not be construed as limited to the embodiments set forth herein. Rather, these embodiments are provided so that this disclosure will be thorough and complete, and will fully convey the scope of the system and method disclosed herein to those skilled in the art.

As will be appreciated by those skilled in the art, portions of the present system and method may be embodied as a method, data processing system, or computer program product. Accordingly, these portions of the present system and method disclosed herein may take the form of an entirely hardware embodiment, an entirely software embodiment, or an embodiment combining software and hardware aspects. Furthermore, portions of the present system and method may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present system and method is described below with reference to illustrations of methods, systems, and computer program products according to the disclosed embodiments. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

Embodiments of present system and method may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc.

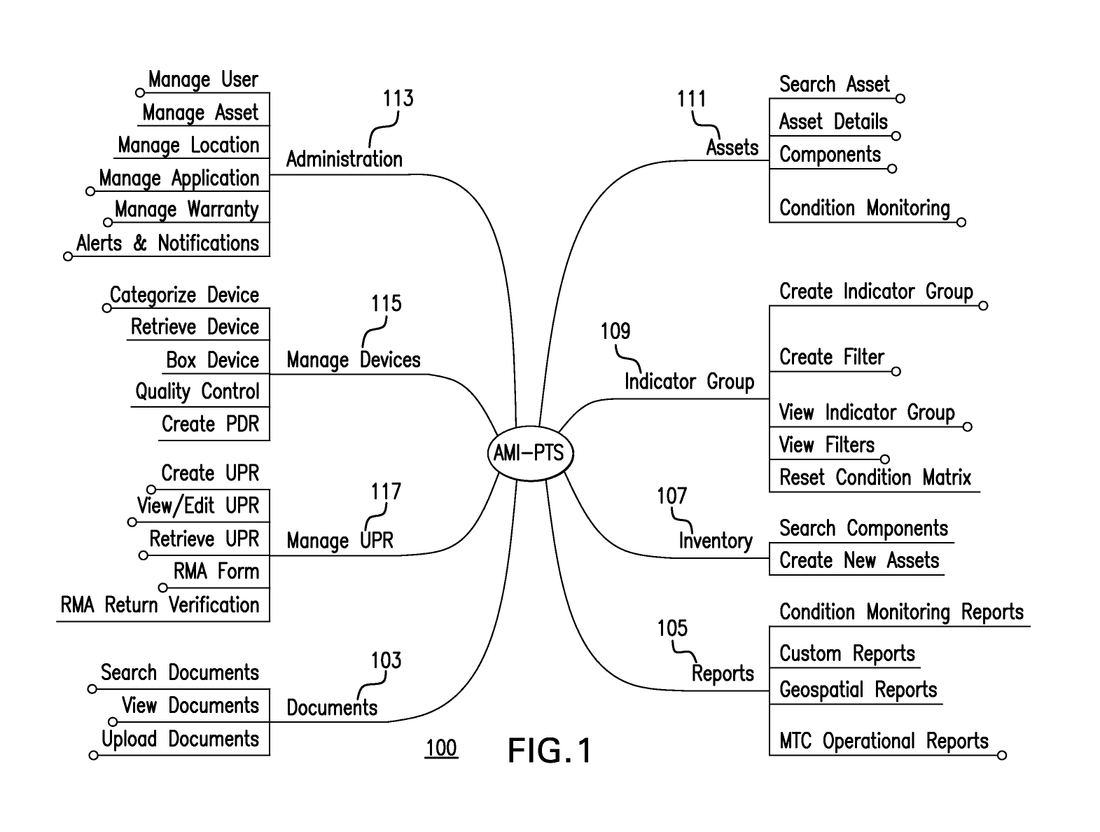

FIG. 1 illustrates a mindmap 100 of the AMI-PTS in accordance with one embodiment. At the center of the map lies the AMI-PTS. Branching out and organized by functionality, the map shows a documents module 103, a reports module 105, an inventory module 107, an indicator group module 109, an assets module 111, an administrator module 113, a device management module 115, and an unsatisfactory performance report (UPR) management product 117.

The administrator module 113 includes functionality that permits management of different features associated with assets (user management, asset management, location management, application management, warranty management, and alerts and notifications management). For example, through the warranty management submodule, the warranty information for a particular asset can be managed and/or accessed.

The assets module 111 includes functionality that allows the system to search for assets in the AMI, access assets details, view component information for a particular asset, and monitor the condition of an asset.

The devices management module 115 includes functionality that allows the system to categorize devices, retrieve information from the PTS database, create a product disposal report (PDR), etc. The term “box device” refers to a device, such as a meter, that has gone through a series of processes, tests, events or actions and that is ultimately placed in a box to secure the device and to potentially use it as evidence in court, for example. In one scenario, a meter that has been returned from the field goes through a revenue protection process. While in the field, the meter is viewed by a field investigator when there is a suspicion that a customer is stealing power from the utility. The meter is pulled out and replaced with a new meter. The meter that has been pulled out may indicate the reason for having been pulled out. The field meter crew goes back to the meter shop and puts the removed meter in a box that is attached a revenue protection tag and is then sent to the MTC for testing. Once the MTC validates the meter and/or the reason for the removal (e.g., tampering), the meter is placed in a box and the meter will be ready to be introduced as evidence in Court, for example.

The term “quality control” refers to the process applied to meters sent back to the manufacturer and returned by the manufacturer to ascertain whether the returned meter properly works.

The manage UPR module 117 includes functionality that allows the system to create, retrieve (e.g., pull data), edit, view (e.g., view information displayed on a screen) the UPR. This module also allows the system to create, edit, view and print of return material authorization (RMA) forms and verification of RMA returns.

The documents search module 103 provides functionality that allows the system to search, upload, and view documents.

The indicator group module 109 includes functionality that allows the system to monitor intrinsic device failures by setting thresholds of smart meter events, monitor event-based conditions to determine asset failures, and apply a dynamic business rule engine (“DBRE”) design for predictive analytics.

The inventory module 107 provides functionality that allows the system to search for components and create new assets.

The reports module 105 provides functionality that allows the system to provide conditioning monitoring reports, create custom reports, create geospatial reports, and generate Meter Technology Center (“MTC”) reports.

The asset 111 and inventory 107 modules provide a 360 degree view of smart assets; allow for a seamless flow of smart asset information from DACS, UIQ, AMI, DWH and CIS; and allow creation of smart meter and network device work orders.

The manage devices 115 and manage UPR 117 modules enable tracking of vendor warranty claims for smart assets, testing and UIQ verification for refurbished smart assets, and work flow integration for LMS Devices. A LMS (load management system) manages, among other things, a load control transponder (LCT).

A manage calibration module (not illustrated) tracks the costs of calibrating devices and equipment used to test smart assets, locates tracking of devices and equipment used in engineering lab, maintains standard operating procedures (SOPs), and maintains product documentation version control.

The indicator group module 109 monitors intrinsic device failures by setting thresholds of smart meter events, performs event based condition monitoring to proactively determine asset failures, and implements a dynamic business rule engine (“DBRE”) design for predictive analytics to determine asset failures. For example, the DBRE may be given different attributes (such as things that are to be monitored) and it then shows results used to determine asset failures.

The reports and dashboards module 105 provides a geo-spatial view to visualize the devices returning to MTC, monitors vendor performance service level agreements (SLAs), plans work in queue, and key performance indicators (KPIs) to track productivity.

The administration module 113 creates dynamic roles for users and manages users, configures alerts and notifications, and provides a friendly user interface to configure settings and administrative features.

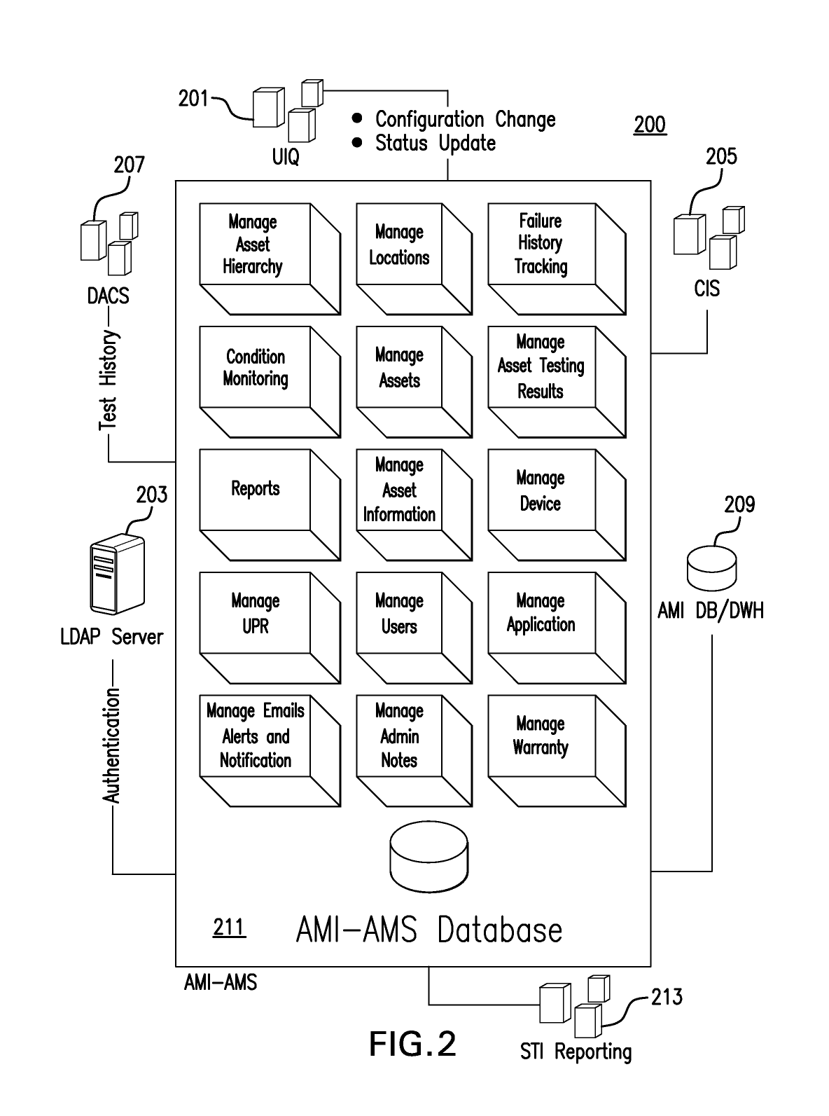

FIG. 2 illustrates a Context Diagram 200 of the system in accordance with one embodiment. In FIG. 2, the UIQ module 201 may be defined as an AMI command and control module that interfaces with assets in the AMI network. The LDAP server 203 determines whether the login ID and password provided by a user of the AMI-PTS system matches a login ID and password stored in the utility's database. Thus, the authentication function is performed by the LDAP server. Upon authentication, the client can access account information stored in the CIS server 205. The Distributed Access Control System (DACS) 207 is a light-weight single sign-on and role-based access control system for web servers and server-based software. The AMI DB/DWH 209 is a data warehouse for data collected from the AMI network. The AMI-AMS Database 211 stores attributes, configuration, location, associated work and reliability history for smart meter and device assets.

The AMI-AMS Database 211 may store tables corresponding to some or all of the modules and submodules illustrated in FIG. 1. In the embodiment illustrated in FIG. 2, the AMI-AMS Database 211 includes tables or submodules related to the following functions: Message Asset Hierarchy, Message Locations, Failure History Tracking, Condition Monitoring, Manage Assets, Manage Asset Testing Results, Reports, Manage Asset Information, Manage Device, Manage UPR, Manage Users, Manage Applications, Manage Email Alerts and Notification, Manage Admin Notes, and Manage Warranty.

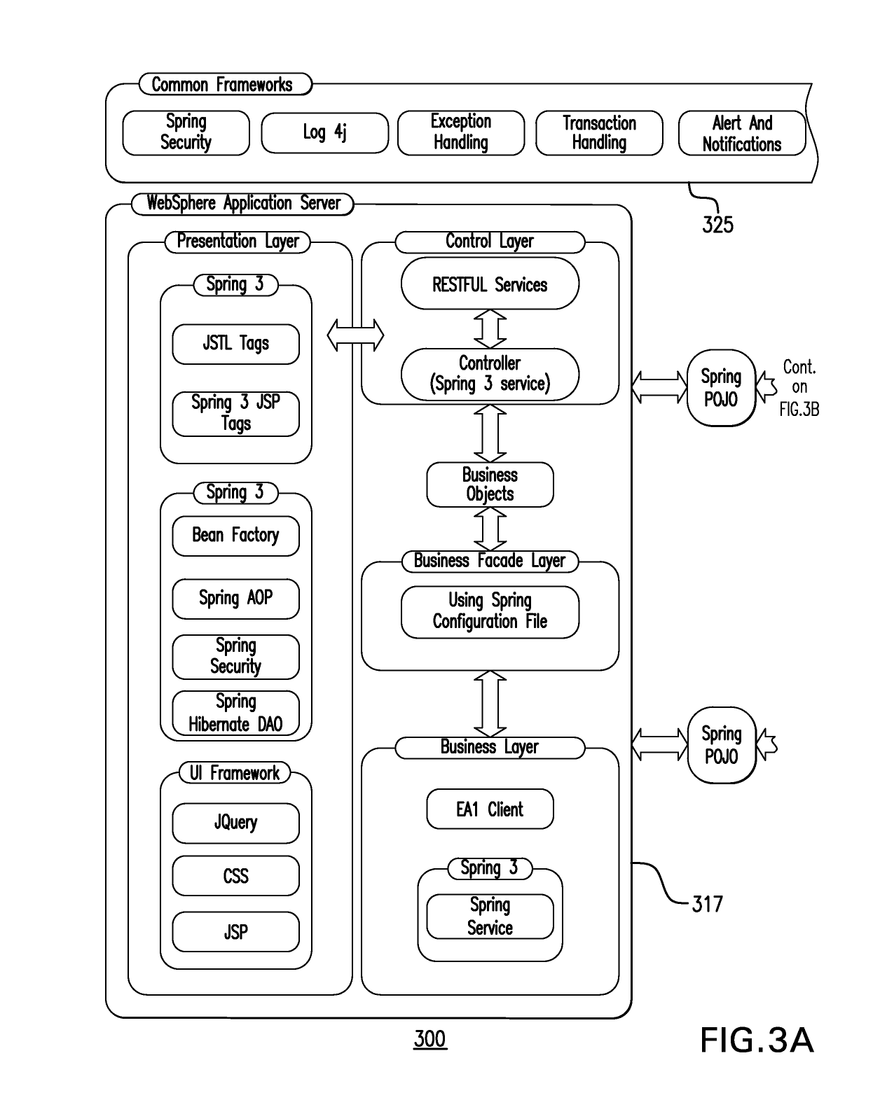

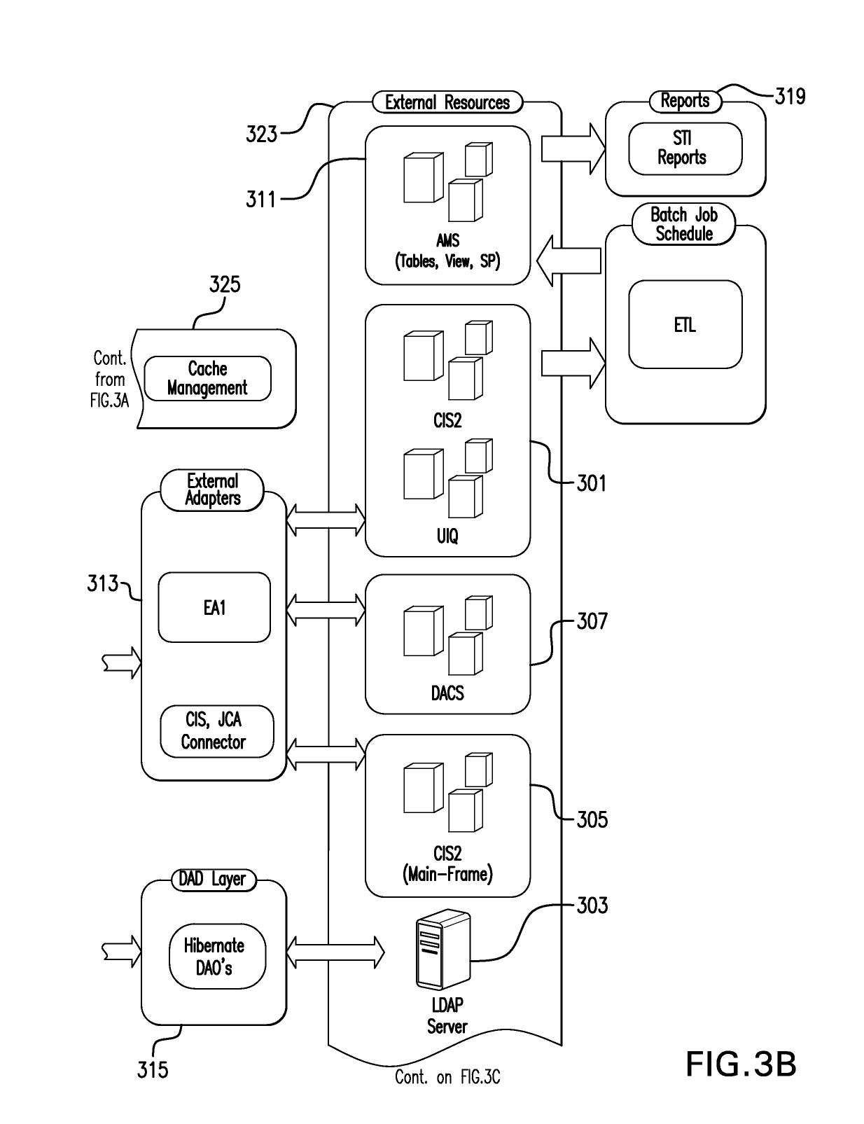

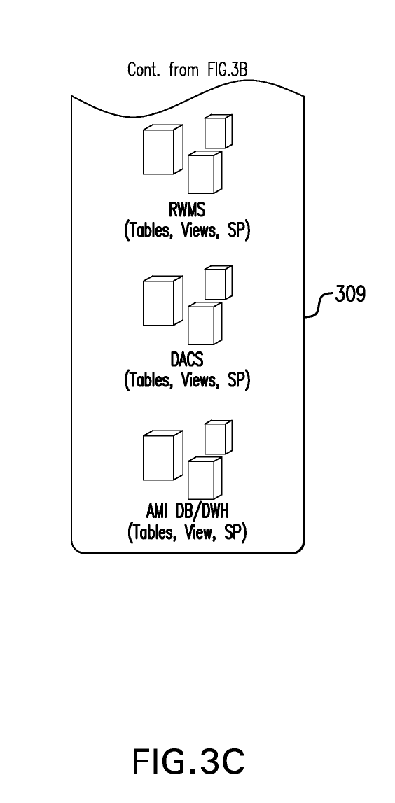

FIG. 3 illustrates an exemplary architecture of the system in accordance with one embodiment. In the system illustrated in the figure, the following software is used: Java server pages (JSP), Cascaded style sheet (CSS), JQuery is a Java scripting language, Spring framework, Enterprise Application Interface (EAI), Data Access Object layer (DAO), Extract Transform and Load (ETL).

FIG. 3 shows the interconnectivity of main architecture of Websphere Application Server components 317 to external resources 323, Reports 319, and Batch Job Scheduler 321. External Adapters 313 are used to communicate to CIS and UIQ applications. DAO layer 315 is used to connect to Distribution Asset management (AMS), RWMS and AMI data warehouse tables and views. Common services frameworks (325) uses Spring security for implementing Java application authentication services; Log4j framework is used for logging; Spring POJOs (Plain Old JAVA object) may be used to implement the process and application services.

Batch jobs may be defined as scheduled programs that run without user intervention and to automate tasks that they need to perform on a regular basis. This will happen through ETL (Extract Transform Load) job and Control-M (a job scheduler for applications which may run tasks at a certain time).

Common services may be defined as self-contained, reusable components that can be plugged into any of the components of other layers to realize the desired functionalities. The services may include authentication and authorization and logging.

The architecture may be used to implement a number of layers, for example, a presentation later, a façade layer, a business layer, an integration layer, a data access layer, and a resource layer.

A Presentation layer may be defined as the entry point for all user interactions through a browser. It may be implemented using a Spring 3.1 MVC Framework.

The Business Facade layer is used to define a unified, higher level interface to the connected subsystems, wrapping the subsystem class libraries to simplified interfaces.

Business layer components may be self-contained functionalities that own transaction management and coordination with other components. The Business layer may also provide a platform for exposing reusable components as web services.

The Integration layer may be used to decouple the communication with EAI layer. It leverages the existing EAI (Enterprise Application Integration) layer for integrating with CIS2 and other external systems.

The Data access layer may be used to centralize the data access needs of the entire application. The logic necessary to access the data store may abstracted into the Data access layer. The open source program Hibernate may be used to implement the Data Access Layer.

The Resource Layer may include databases and other external systems for persisting and accessing data. The Resource Layer may include the following systems and components.

1. The Customer Information System (CIS2) may store customer premise details along with the master meter inventory.

2. The Data Acquisition and Collection System (DACS) may be used to capture the asset test results in a Meter Technology Center (MTC).

3. The Utility IQ (UIQ) may also be defined as a head-end system provided to manage AMI network and to store the events generated by smart meters, access points, relays, and firmware versions.

4. The AMI Data Warehouse (AMI DWH) may be used to maintain historical data from UIQ, including events, attributes, etc.

5. The EAI Services may be used to build services for the AMI-PTS to interface with other systems in real-time.

6. The AMI-PTS database may store information about assets, failure reporting, condition monitoring and documents.

7. The LDAP Server may be used to leverage existing authentication schemes.

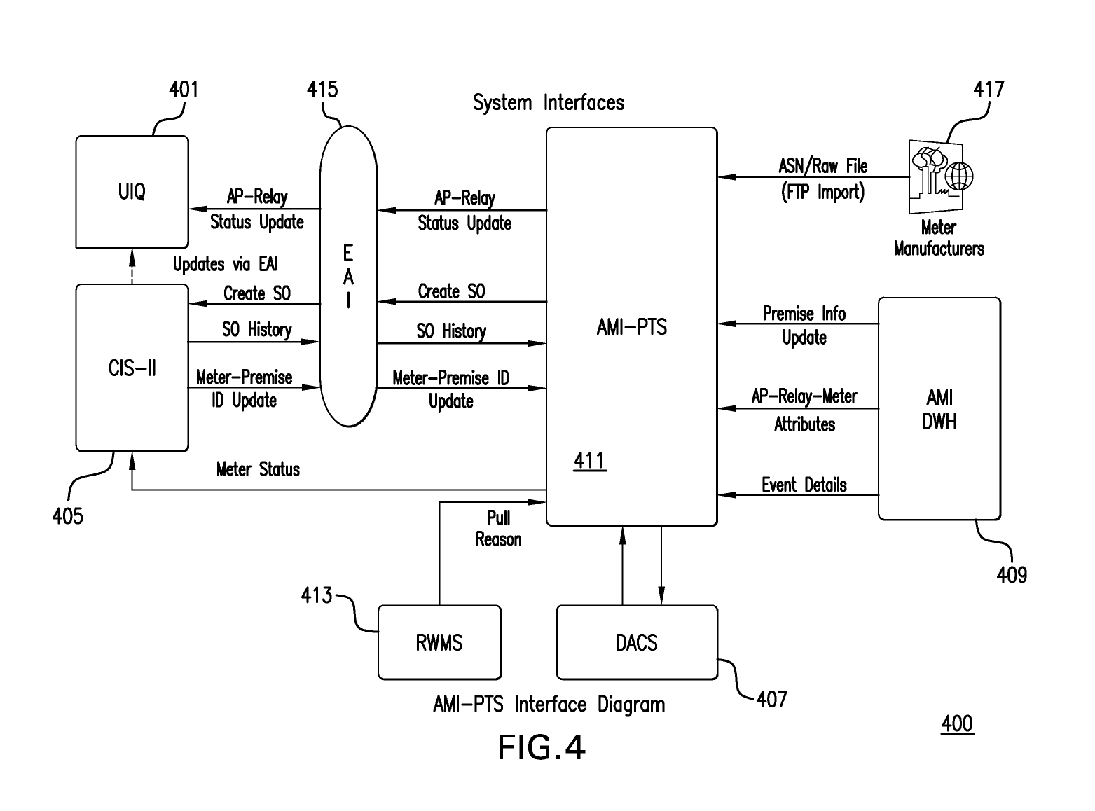

FIG. 4 illustrates an AMI-PTS interface diagram 400 in accordance with one embodiment. In the system illustrated in the figure, the following software, systems or modules are used: Data Warehouse (DWH) 409, Enterprise Application Interface (EAI) 415, Routine Work Management System (RWMS) 413, CIS 405, UIQ 401, and AMI-PTS 411. EAI may be defined as an enterprise application interface that works as an intermediate layer between PTS and RWMS (like middleware). RWMS may be defined as a process defined by the utility which is applied to meters pulled from the field.

The AMI-PTS application 411 is closely integrated with external systems such as CIS II 405, DACS 407, UIQ 401, RWMS 413 and data sources such as the AMI Data Warehouse 409 and data provided by meter manufacturers 417.

The AMI-PTS application may interface with CIS II so that CIS II provides premise information, service order (SO) details and AMI-PTS sends the service order request to CIS II. Meter status may be updated by the AMI-PTS to CIS II and in turn CIS II may update UIQ accordingly.

The AMI-PTS application may interface with UIQ so that UIQ provides important asset attributes to AMI-PTS and AMI-PTS updates UIQ with the status of access points and relays.

The AMI-PTS application may interface with DACS so that DACS sends test details (in-house and/or third party vendor) to AMI-PTS.

The AMI-PTS application may interface with RWMS (Routine Work Management System) so that RWMS sends “Pull Reason” (i.e., reason for pulling a meter) to AMI-PTS.

The AMI-PTS application may interface with AMI-DWH so that AMI-DWH provides event data for indicator groups and condition monitoring.

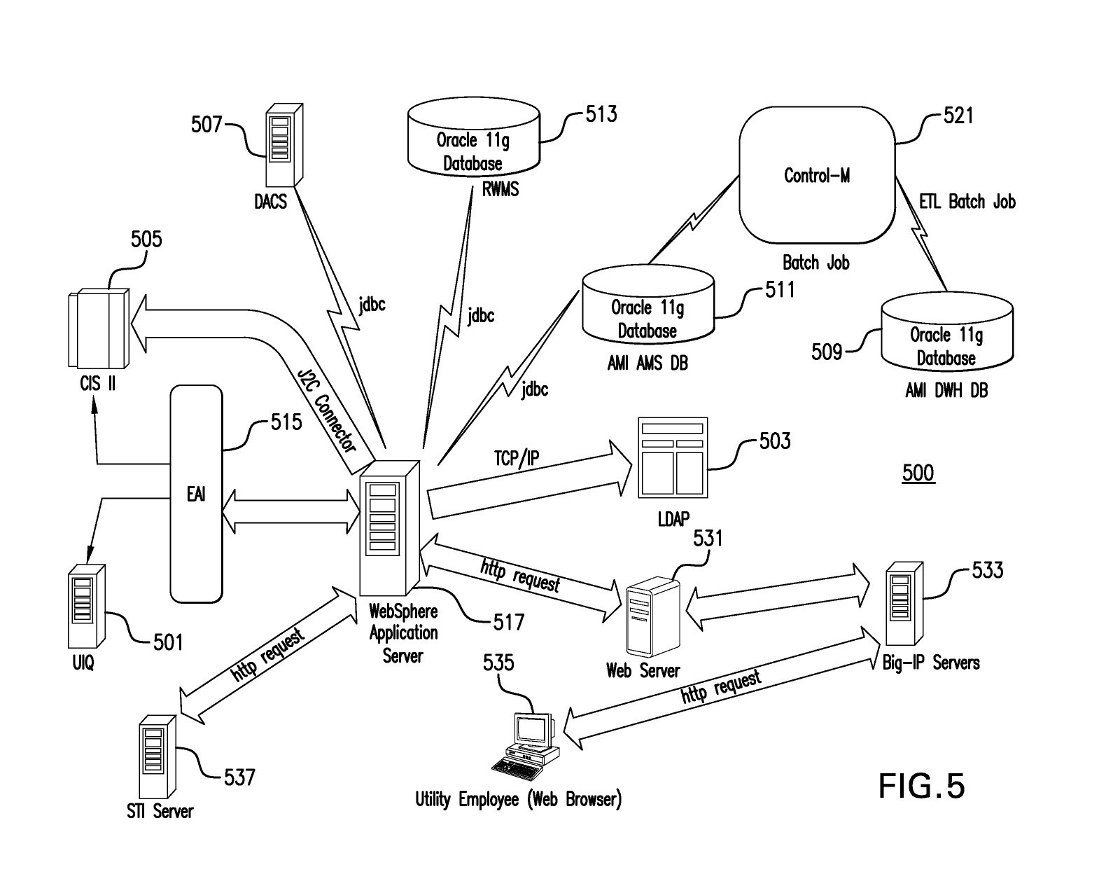

FIG. 5 illustrates an exemplary physical architecture 500 of the AMI PTS system in accordance with one embodiment. In FIG. 5, a utility employee may access the AMI-PTS system through a browser installed in a computer 535 and enter a login ID and user password. The login ID and user data may be encrypted by the computer 535 and are then routed through a number of servers (e.g., servers 533 and 531) and firewalls until they reach the Websphere application server 517. The data from the computer 535 is received by the Websphere server 517 through a webservice or http request. The Websphere server 517 interprets the Websphere calls and translates the message into a format that can be interpreted by the CIS II terminal 505 and the LDAP server 503. The Websphere server 517 may communicate with the CIS II 505 and the UIQ 501 through the EAI interface 515.

Utility employee, using a web browser, enters login ID and password. The login ID and password are decrypted by the Websphere application server 517. The decrypted login ID and password are then forwarded to the LDAP server 503. The LDAP server determines whether the login ID and password match a login ID and password stored in DACS repository 507. Thus, the authentication function is performed by the LDAP server 503. Upon authentication, the utility employee can access data from the CIS II 505, UIQ 501, RWMS 513, STI server 537, the AMI AMS database 511 and the AMI DWH database 509 (through Control-M 521).

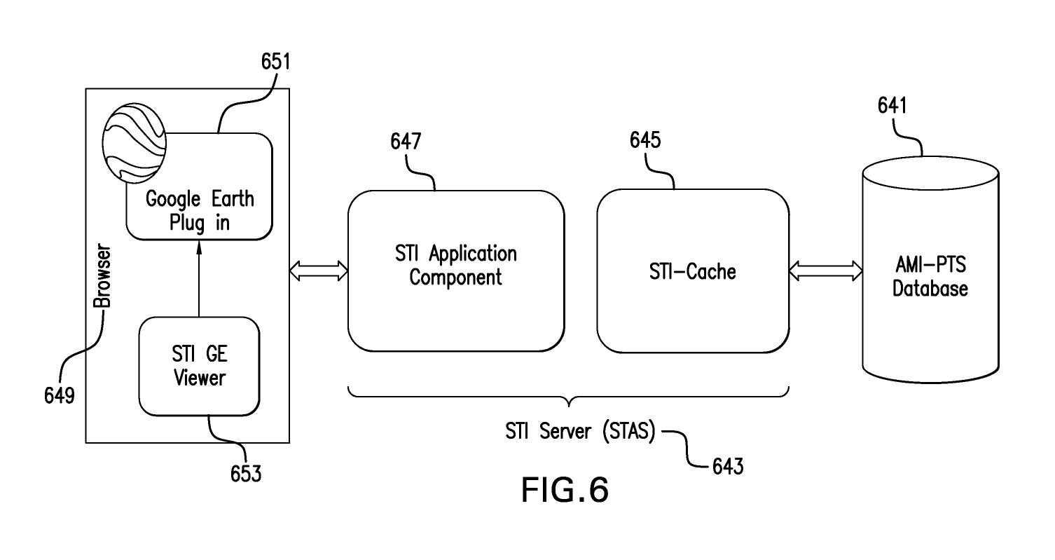

FIG. 6 illustrates a Dashboard architecture 600 for use with the AMI PTS system in accordance with one embodiment. The STI module or server 643 refers to space time insight reporting. Space Time Insight (STI) is a software development tool for integrating data sources into visualization.

The architecture 600 may be used for integrating the AMI-PTS database 641 with other third party tools, including STI 643, Google Earth 651, web browsers 649, etc. The STI cache 645 may be defined as application libraries that support executable applications. The STI application component 647 may be defined as a tool layer that enables a developed AMI-PTS application to work. The STI GE Viewer 653 may be defined as a tool component to present data on a Google Earth map. The Google Earth Plug-in 651 is the tool from Google Earth that may be used for integration with the AMI-PTS application via the STI GE viewer 653. The browser 649 may be any web browser used to display STI applications.

Further referring to FIG. 6, the STI server 643 may also include application libraries that support executable applications; a body or repository of widgets (visuals) to make up the STI application; and a tool layer that enables the developed STI application to work. These STI tools support the collection of inputs from the network (meters, relays, access points, scheduled read jobs to pull meter usage, etc.) through the AMI-PTS database 641 and the pairing and export of specific data transactions to create data marts for enterprise business consumption. The data generated by the AMI-PTS database 641 may be used by various widgets.

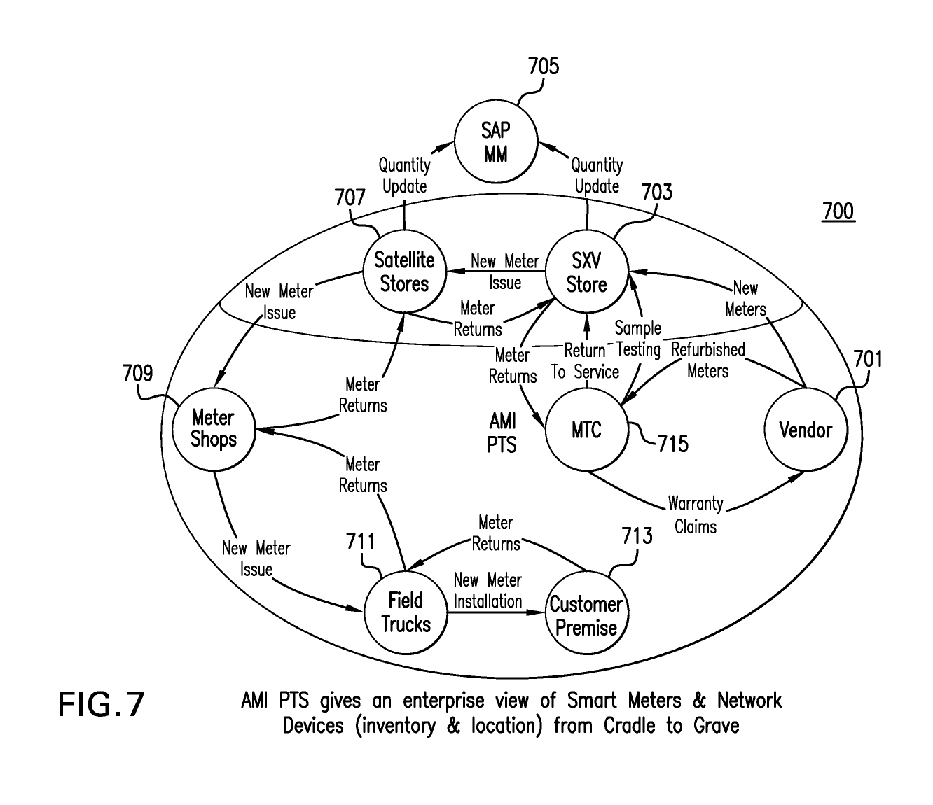

FIG. 7 illustrates an enterprise view 700 of the life cycle of products in accordance with one embodiment. The life cycle includes transactions associated with the deployment of products, including issuance of new meters, issuance of refurbished meters, sample testing of meters, installation of meters, meter returns, quantity updates, transmission of warranty claims, and meter returns for servicing. The main entities associated with these transactions may include the meter vendor 701, a Meter Technology Center 715, the SXV store 703, the SAP MM 705, satellite meter stores 707, meter shops 709, field trucks 711 and customer premises.

The term “quantity updates” refers to a number of quantity level. For example, if the utility bought 1000 meters, to see if there is interfacing between PTS and the SAP MM module the quantity of meters would be provided to the MM module. The SAP MM module refers to a material module used to conduct material management and which is commercially available from SAP. The term “material management” refers to providing a bill of leave to the owner of the MM module (e.g., SAP) when a truck comes to the store and gives the utility a load of meters. The term “SXV” is used as a store identifier. A “satellite meter store” may be used to keep inventory of some meters. A meter shop may receive and send meters to satellite stores for storage—the meter shop may be another hub for store meters.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112-2, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A system for tracking AMI assets comprising:
a product tracking database; and
a plurality of interfaces for providing access to said database to
an administration module,
a device management module,
an UPR management module,
a documents module,
an assets module,
an indicator group module,
an inventory module, and
a reports and dashboard module.

2. The system of claim 1, wherein the administration module permits management of different features associated with said AMI assets and comprises user management, asset management, location management, application management, warranty management, and alerts and notifications management submodules.

3. The system of claim 1, wherein the assets submodule includes an AMI asset submodule, an access AMI assets details submodule, a view component information for a particular AMI asset submodule and an AMI asset condition monitoring submodule.

4. The system of claim 1, wherein the device management module comprises device categorization, device retrieval, box device, quality control, and PDR creation submodules.

5. The system of claim 1, wherein the UPR management module comprises an UPR creation submodule, an UPR retrieval submodule, an UPR display and modification submodule, a return material authorization submodule.

6. The system of claim 5, wherein the return material authorization submodule allows the system to create, edit, view and print of return material authorization forms and verification of return material authorization returns.

7. The system of claim 1, wherein the documents submodule comprises search document, view document, and upload documents submodules.

8. The system of claim 1, wherein the indicator group module allows the system to monitor intrinsic device failures by setting thresholds of smart meter events, monitor event-based conditions to determine AMI asset failures, and apply a dynamic business rule engine for predictive analytics.

9. The system of claim 1, wherein the inventory module allows the system to search for components and create new AMI assets.

10. The system of claim 1, wherein the reports module allows the system to provide conditioning monitoring reports, create custom reports, create geospatial reports, and generate Meter Technology Center reports.

11. The system of claim 1, wherein the asset and inventory modules provide a 360 degree view of smart AMI assets; allow for a seamless flow of smart AMI asset information from DACS, UIQ, AMI, DWH and CIS; and allows creation of smart meter and network device work orders.

12. The system of claim 1, wherein the device management and UPR management modules enable tracking of vendor warranty claims for smart AMI assets, testing and UIQ verification for refurbished smart AMI assets, and work flow integration for LMS devices.

13. The system of claim 1, further comprising:
a calibration module for tracking the costs of calibrating devices and equipment used to test smart AMI assets, locating tracking of devices and equipment used in engineering labs, maintaining standard operating procedures, and maintaining product documentation version control.

14. The system of claim 1, wherein the indicator group module monitors intrinsic device failures by setting thresholds of smart meter events, performs event based condition monitoring to proactively determine asset failures, and implements a dynamic business rule engine for predictive analytics to determine asset failures.

15. The system of claim 1, wherein the reports and dashboards module provides a geo-spatial view to visualize the devices returning to a meter technology center, monitors vendor performance service level agreements, plans work in queue, and tracks productivity of smart AMI assets through use of key performance indicators.

16. A system for tracking AMI assets comprising:
a product tracking database in communication with
a DACS;
an LDAP server;
a CIS server;
an AMI data warehouse;
an UIQ system; and
an RWMS system;
wherein the product tracking database communicates with the UIQ system and the CIS server through EAI services; and
wherein the product tracking database comprises:
an administration module,
a device management module,
an UPR management module,
a documents module,
an assets module,
an indicator group module,
an inventory module, and
a reports and dashboard module.

17. The system of claim 16, wherein the CIS server stores customer premise details and a master meter inventory.

18. The system of claim 16, wherein the DACS captures asset test results in a meter technology center.

19. The system of claim 16, wherein the UIQ system is a head-end system provided to manage an AMI network and to store the events generated by smart meters, access points, relays, and firmware versions.

20. The system of claim 16, wherein the product tracking database stores information about assets, failure reporting, condition monitoring and documents generated by the system for tracking AMI assets.

21. The system of claim 1, wherein the product tracking database stores information about assets, failure reporting, condition monitoring and documents generated by the system for tracking AMI assets.
